(19) United States
(12) Patent Application Publication
(10) Pub. No.: US 2024/0132362 A1
(43) Pub. Date: Apr. 25, 2024

(54) QUANTUM DOT SENSITIZED PHOTOREDUCTION OF CARBON DIOXIDE

(71) Applicant: Northwestern University, Evanston, IL (US)

(72) Inventors: Francesca Arcudi, Evanston, IL (US); Luka Dordevic, Evanston, IL (US); Emily A. Weiss, Evanston, IL (US); Benjamin Nagasing, Evanston, IL (US); Samuel l. Stupp, Evanston, IL (US)

(21) Appl. No.: 18/547,818

(22) PCT Filed: Feb. 28, 2022
(86) PCT No.: PCT/US2022/018147

§ 371 Date: Aug. 24, 2023

(51) Int. Cl. C01B 32/40; B01J 19/12; B01J 31/18; B01J 35/27; B01J 35/39; C09K 11/02; C09K 11/62

(52) U.S. Cl. CPC C01B 32/40; B01J 19/127; B01J 31/182; B01J 35/27; B01J 35/39; C09K 11/025; C09K 11/623; B01J 2219/0884; B01J 2219/0892; B01J 2219/1203; B01J 2231/005; B01J 2231/625; B01J 2531/845; B82Y 20/00

(57) ABSTRACT

Disclosed herein are compositions and methods that can achieve photoreduction of CO₂ to CO in pure water at pH 6-7 with excellent performance parameters. In embodiments, the compositions and methods use CuInS₂ colloidal quantum dots (QDs) as photosensitizers, and a Co-porphyrin catalyst.

### CROSS-REFERENCE TO RELATED APPLICATIONS

This application claims priority to and the benefit of U.S. Provisional Patent Application No. 63/154,319, filed on Feb. 26, 2021, which is incorporated herein by reference in its entirety.

### STATEMENT REGARDING FEDERALLY SPONSORED RESEARCH

This invention was made with government support under DE-SC0000989 awarded by the United States Department of Energy. The government has certain rights in the invention.

### TECHNICAL FIELD

Disclosed herein are compositions and methods that can achieve photoreduction of CO₂ to CO in pure water at pH 6-7 with excellent performance parameters. In embodiments, the compositions and methods use CuInS₂ colloidal quantum dots (QDs) as photosensitizers, and a Co-porphyrin catalyst.

### BACKGROUND

Solar energy is by far the largest source of clean, renewable energy for sustainable, carbon-neutral fuel production. Direct solar-to-fuels systems, which co-localize the functions of light absorption, charge separation, and redox-driven chemistry, have emerged as an alternative to photovoltaic-driven electrochemical cells because they avoid the fabrication processes associated with Si (or other efficient) solar cells, and can, in principle, be designed to access a greater variety of chemical products useful for fuel and agriculture. Photocatalytic systems for direct production of CO from CO₂ are expected to play a major part in solar fuels cascade networks, but the best-performing systems are still far from technologically relevant targets.

High-turnover, robust, selective systems for conversion of CO₂ to CO have been realized in aprotic organic solvents or partially aqueous media (see, e.g., Cancelliere et al. Chem. Sci. 11, 1556-1563 (2020); Ma et al. J. Am. Chem. Soc. 142, 6188-6195 (2020); Ouyang et al. Angew. Chem. Int. Ed. 57, 16480-16485 (2018); Guo et al. J. Am. Chem. Soc. 138, 9413-9416 (2016); Kuramochi et al. Inorg. Chem. 53, 3326-3332 (2014); and Thoi et al. J. Am. Chem. Soc. 135, 14413-14424 (2013)). In most cases, these systems comprise electrocatalysts capable of driving CO₂ reduction in combination with photosensitizers—typically based on expensive metals such as ruthenium or iridium—that absorb light and donate electrons to the catalyst. This work represents an important advance, but the opportunity to source electrons for CO₂ reduction from water oxidation, plus the abundance and zero environmental impact of water, motivates the development photocatalytic reactions that operate in pure water. Fully aqueous photocatalytic reduction of CO₂ must however overcome (i) a low selectivity for carbonaceous products due to kinetically and thermodynamically favored proton reduction (Costentin et al. Chem. Soc. Rev. 42, 2423-2436 (2013)), and (ii) the poor solubility of CO₂ in water ([CO₂]=0.0383 M at 298 K under 1 atm) (Lide, D. R. Handbook of Chemistry and Physics. (CRC, Boca Raton, FL, 2000)). There are few encouraging reports of aqueous photocatalytic CO₂ reduction (Call et al. ACS Catal. 9, 4867-4874 (2019); Bi et al. ACS Catal. 8, 11815-11821 (2018); Kuehnel et al. J. Am. Chem. Soc. 139, 7217-7223 (2017); Nakada et al. Green Chem. 18, 139-143 (2016); Chaudhary et al. Chem. Commun. 48, 58-60 (2012); Pitman et al. J. Am. Chem. Soc. 138, 2252-2260 (2016)). However, the performance of these systems severely lags that of analogous non-aqueous systems. Furthermore, a CO-evolution system that simultaneously performs well with respect to all three key metrics—turnover number (TON), quantum yield (QY) and selectivity (S_{CO})—has proven challenging both in organic solvents and in aqueous media.

### SUMMARY

Disclosed herein is a method of converting carbon dioxide to carbon monoxide, the method comprising:
providing a reaction mixture comprising quantum dots, a cobalt(III) porphyrin compound, and a reducing agent in water;
adding carbon dioxide to the reaction mixture; and
illuminating the reaction mixture with light.

In some embodiments, the quantum dots are core/shell quantum dots comprising a CuInS₂ core and a ZnS shell. In some embodiments, the quantum dots further comprise a capping molecule on the surface of the quantum dots. In some embodiments, the capping molecule comprises a thiol moiety and an amine moiety. In some embodiments, the capping molecule is 2-aminoethanethiol. In some embodiments, the quantum dots are present in the mixture at a concentration of about 1 μM to about 5 μM.

In some embodiments, the cobalt(III) porphyrin compound is selected from [{meso-tetra(4-sulfonatophenyl)porphyrinato}cobalt(III)] and [{meso-tetra(4-carboxyphenyl)porphyrinato}cobalt(III)]. In some embodiments, the cobalt(III) porphyrin compound is [{meso-tetra(4-sulfonatophenyl)porphyrinato}cobalt(III)]. In some embodiments, the cobalt(III) porphyrin compound (e.g., {{meso-tetra(4-sulfonatophenyl)porphyrinato}cobalt(III)] or [{meso-tetra(4-carboxyphenyl)porphyrinato}cobalt(III)]) is present in the reaction mixture at a concentration of about 0.10 μM to about 5.0 μM.

In some embodiments, the reducing agent is selected from sodium ascorbate, tris(carboxyethyl)phosphine, and a mixture thereof. In some embodiments, he reducing agent is present in the reaaction mixture at a concentration of about 5 mM to about 100 mM.

In some embodiments, the reaction mixture does not comprise an organic solvent or a buffer. In some embodiments, the reaction mixture has a pH of about 6 to about 7.

In some embodiments, the method comprises illuminating the reaction mixture with light at a wavelength of about 450 nm. In some embodiments, the method comprises illuminating the reaction mixture with a 450-nm light-emitting diode. In some embodiments, the method comprises illuminating the reaction mixture for about 18 hours to about 96 hours.

In some embodiments, the reaction mixture is contained within a reaction vessel, and carbon dioxide is added to the reaction vessel at a pressure of about 1 atm.

Also disclosed herein is a composition comprising: quantum dots comprising a CuInS₂ core, a ZnS shell, and a capping molecule comprising an amino group; a cobalt(III) porphyrin compound; a reducing agent; and water. In some embodiments, the capping molecule is 2-aminoethanethiol. In some embodiments, the cobalt(III) porphyrin compound is selected from [{meso-tetra(4-sulfonatophenyl)porphyrinato}cobalt(III)] and [{meso-tetra(4-carboxyphenyl)porphyrinato}cobalt(III)]. In some embodiments, the cobalt(III) porphyrin compound is [{meso-tetra(4-sulfonatophenyl)porphyrinato}cobalt(III)]. In some embodiments, the reducing agent is selected from sodium ascorbate, tris(carboxyethyl)phosphine, and a mixture thereof. In some embodiments, the composition further comprises carbon dioxide.

### BRIEF DESCRIPTION OF THE DRAWINGS

FIG. 1 shows an illustration of the structures of the photosensitizer and catalyst used in compositions and methods disclosed herein: quantum dots capped with 2-aminoethanethiol hydrochloride (A-QDs) or 2-mercaptoethyl-N,N,N-trimethylammonium chloride (TMA-QDs); and [{meso-tetra(4-sulfonatophenyl)porphyrinato}cobalt(III)] (CoTPPS).

FIGS. 2A-2C show catalytic performance metrics for methods described herein: (A) concentration of CO as a function of time of irradiation (450-nm, 140 mW·cm⁻²) for samples prepared in 2 mL of CO₂-saturated H₂O; (B) selectivity for CO as a function of time of irradiation (450-nm, 140 mW·cm⁻²) for samples prepared in 2 mL of CO₂-saturated H₂O; (C) TON (CO) vs the cumulative absorbed photon energy (slope=sensitization efficiency). Error bars are calculated from two to three runs; uncertainty is ≤5%. The compositions of all samples are shown in Table 1. The “Ru” sample contains 12 μM of sensitizer (a concentration that matches the absorbance of the QDs samples at 450 nm). The “Ru ref.” sample has a composition optimized in a prior reference (Call et al. ACS Catal. 9, 4867-4874 (2019)).

FIGS. 3A-3C show data from optimizations of turnover number and selectivity of QD systems disclosed herein: (A) through variation of A-QDs concentration in the presence of 0.25 μM CoTPPS and 100 mM NaAsc; (B) through variation of CoTPPS concentration in the presence of 2.5 μM A-QDs and 100 mM NaAsc; (C) through variation of NaAsc concentration in the presence of 2.5 μM A-QDs and 0.25 μM CoTPPS. Error bars indicate standard error of the mean, calculated from two to three runs, and the typical uncertainty is ≤5%.

FIG. 4 shows turnover number as a function of irradiation time for samples containing 2.5 μM of CoTPPS and 2.5 μM of A-QDs, prepared using 2 mL of CO₂-saturated H₂O, and irradiated with 450-nm light (140 mW·cm⁻²). A-QDs contain 25 mM of NaAsc. A-QDs+TCEP contain 5 mM of NaAsc and 5 mM of TCEP. The pH was 6.0 before bubbling with CO₂. Error bars indicate standard error of the mean, calculated from two to three runs, and the typical uncertainty is ≤5%.

FIGS. 5A-5D show: (A) GC-MS chromatograms peaks (retention time of CO) with traces of m/z=12 and 13 of the A-QDs-CoTPPS system in H₂O (pH 6.2) irradiated (450 nm) for 18 h saturated with CO₂; (B) GC-MS chromatograms peaks (retention time of CO) with traces of m/z=12 and 13 of the A-QDs-CoTPPS system in H₂O (pH 6.2) irradiated (450 nm) for 18 h saturated with ¹³CO₂; (C) a ¹³C NMR spectrum of 0.23 mM A-QDs in H₂O/D₂O (9:1 v/v) after exposure with ¹³C-labeled CO₂. The measured pH before exposure was 6.1. The peak at 160.82 ppm is assigned to carbamic acid. The peak at 125.3 ppm is assigned to ¹³CO₂. Also shown is an illustration of the QDs with a carbamic acid moiety; and (D) cyclic voltammograms of CoTPPS with and without A-QDs in H₂O (pH 6.5) supported with 0.1 M KCl and saturated with CO₂. Scan rate was 50 mV·s⁻¹. The vertical dashed lines show the onset of catalytic current for CO₂ reduction potentials, determined from the intersection of the tangents between the baseline and the signal current.

FIG. 6 shows TOF_{CO} as a function of irradiation time for samples containing 2.5 μM of CoTPPS and 0.25 μM of A-QDs, prepared using 2.0 mL of CO₂-saturated H₂O, and irradiated with 450 nm light (140 mW·cm⁻²). A-QDs contain 25 mM of NaAsc. A-QDs+TCEP contain 5 mM of NaAsc and 5 mM of TCEP. The pH was 6.0 before bubbling with CO₂. Error bars indicate standard error of the mean, calculated from two to three runs, and the typical uncertainty is ≤5%.

FIGS. 7A-7B show evolution of the absorption spectrum of the A-QD reaction mixture with irradiation time. Absorption spectra of 2.0 mL of CO₂-saturated H₂O containing 0.25 μM CoTPPS, 2.5 μM A-QDs, and 25 mM NaAsc (Table 1, entry 1) (FIG. 7A) in the dark and (FIG. 7B) upon irradiation at 450 nm (140 mW·cm⁻²). The pH was 6.0-6.2 before bubbling with CO₂.

FIGS. 8A-8D show Evolution of the absorption spectrum of the A-QDs with irradiation time. Absorption spectra of 3.0 mL of CO₂-saturated H₂O containing 1.4 μM A-QDs (the pH was 6.0 before bubbling with CO₂) (FIG. 8A) without and (FIGS. 8B-8D) with various concentrations of dehydroascorbic acid (DHA).

FIGS. 9A-9B show NMR spectroscopy (FIG. 9A) ¹H NMR and (FIG. 9B) ¹³C NMR spectra of cysteamine hydrochloride and cystamine dihydrochloride (both ˜5 mM, D₂O) and A-QDs-CoTPPS (2.5 mM A-QDs, 0.25 mM CoTPPS, D₂O) under CO₂ (1 atm) at t=0 h, t=16 h kept in the dark and irradiated with 450 nm light (140 mW·cm⁻²) for 16 h. The pH was 6.2 before bubbling with CO₂.

FIGS. 10A-10B show: (FIG. 10A) GC-MS chromatograms (retention time of CO, O₂ and N₂) with extracted ion currents of m/z=13, 29 and 45 for the A-QD-CoTPPS system in H₂O (pH 6.2) irradiated (450 nm) for 18 h saturated with CO₂ (red) and ¹³CO₂ (black); (FIG. 10B) MS spectrum of the 2.65 mM peak (from total ion current; m/z=32, 16 corresponds to oxygen and m/z=40 to argon).

FIGS. 11A-11B show NMR spectroscopy of labeled system: (FIG. 11A) ¹³C NMR spectra of 0.2 mM A-QDs in H₂O/D₂O (9:1 v/v, pH 6.0) after freeze-pump-thaw cycles and exposure with ¹³CO₂ (FPT→¹³CO₂) and further freeze-pump-thaw cycles (FPT→¹³CO₂→FPT); (FIG. 11B) ¹³C NMR spectra of 0.2 mM A-QDs in H₂O/D₂O (9:1 v/v, pH 6.2) after freeze-pump-thaw cycles and exposure with ¹³CO₂ and further purge with He (CO₂→He) for 5, 10 or 15 minutes. The peak at 160.8 ppm is assigned to carbamic acid. The peak at 125.3 ppm is assigned to ¹³CO₂.

FIGS. 12A-12B show GC-MS chromatograms peaks traces of m/z=12 and 13 (retention time of CO) of the A-QDs-CoTPPS system (2.5 mM A-QDs, 1.0 mM CoTPPS, 25 mM NaAsc) in H₂O (pH 6.2) saturated with (FIG. 12A) CO₂ and (FIG. 12B) ¹³CO₂ and further purged with He until there was no CO₂ present in the headspace, then irradiated with 450 nm light (140 mW·cm⁻²) for 18 h.

FIGS. 13A-13C show electrochemical data: (FIG. 13A) Cyclic voltammogram of 0.5 mM CoTPPS (black) in H₂O (pH 6.5) supported with 0.1 M KCl and saturated with Ar. Scan rate was 50 mV·s⁻¹. (FIG. 13B) Cyclic voltammograms of 0.5 mM CoTPPS without (black) and with (blue) 0.5 mM AET or with (red) 1.2 μM A-QDs in H₂O (pH 6.5) supported with 0.1 M KCl and saturated with CO₂. Scan rate was 50 mV·s⁻¹. (FIG. 13C) Cyclic voltammograms of 0.5 mM CoTPPS without (black) and with (green) 0.5 mM TMA or with (violet) 1.2 μM TMA-QDs in H₂O (pH 6.5) supported with 0.1 M KCl and saturated with CO₂. Scan rate was 50 mV·s⁻¹. The vertical dashed lines show the onset of catalytic current for CO₂ reduction potentials, determined from the intersection of the tangent of the signal current and the baseline.

FIG. 14 shows a comparison of the photocatalytic performance for CoTCPP and CoTPPS. Structure of the {[meso-tetra(4-carboxyphenyl)porphyrinato}cobalt(III)] (CoTCPP). TON_{CO} and TON_{H2} for samples containing 2.5 μM of A-QDs, 25 mM of NaAsc, and 0.25 μM of CoTCPP or CoTPPS prepared using 2.0 mL of CO₂-saturated H₂O, and irradiated with 450 nm light (140 mW·cm⁻²) for 18 hours. The pH was 6.0-6.1 before bubbling with CO₂. Error bars indicate standard error of the mean, calculated from two to three runs, and the typical uncertainty is ≤5%.

### DETAILED DESCRIPTION

Disclosed herein are compositions and methods that can achieve photoreduction of CO₂ to CO in pure water at pH 6-7 with excellent performance parameters (turnover number >80,000, quantum yield >5%, sensitization efficiency >95 mol CO/J photon energy absorbed, and selectivity >99%) using CuInS₂ colloidal quantum dots (QDs) as photosensitizers and a Co-porphyrin catalyst. The performance of the QD-driven system greatly exceeds that of a benchmark aqueous system (926 turnovers with a quantum yield of 0.81%, sensitization efficiency of 9.3, and selectivity of 82%; Call et al. ACS Catal. 9, 4867-4874 (2019)).

### Definitions

Unless otherwise defined, all technical and scientific terms used herein have the same meaning as commonly understood by one of ordinary skill in the art to which this invention belongs. However, in case of conflict, the present specification, including definitions, will control. Accordingly, in the context of the embodiments described herein, the following definitions apply.

As used herein and in the appended claims, the singular forms “a”, “an” and “the” include plural reference unless the context clearly dictates otherwise. Thus, for example, reference to “a quantum dot” is a reference to one or more quantum dots.

As used herein, the term “quantum dot” refers to a nanoparticle of one or more semiconductor materials in which electron (and/or exciton) propagation is confined in three spatial dimensions. Non-limiting examples of quantum dot materials include CdSe, CdS, ZnSe, ZnS, PbS, PbSe, CuInS, CuS, lead halide perovskites, and combinations thereof.

### Methods for Photoreduction of CO₂

Disclosed herein are methods for the photoreduction of CO₂ to CO. For example, the disclosed methods comprise steps of: providing a reaction mixture comprising quantum dots, [{meso-tetra(4-sulfonatophenyl)porphyrinato}cobalt(III)], and a reducing agent in water; adding carbon dioxide to the reaction mixture; and illuminating the reaction mixture with light.

A variety of quantum dots may be used in the reaction mixture. For example, the quantum dots may be CuInS₂, CuS, ZnSe, ZnS, CdSe, CdS, PbS, PbSe, or lead halide perovskite quantum dots, or mixtures thereof. In some embodiments, the quantum dots are selected from CuInS₂, CuS, ZnSe, and ZnS quantum dots, and mixtures thereof. In some embodiments, the quantum dots are CuInS₂ quantum dots. In some embodiments, the quantum dots are core/shell quantum dots (see, e.g., Vasudevan et al. J. Alloy Compd. 696, 396-404 (2015)). For example, in some embodiments, the quantum dots have a CuInS₂ core and a ZnS shell. Quantum dots can be purchased from commercial suppliers, or can be prepared by methods known to those skilled in the art. For example, methods for preparing quantum dots include hot-injection methods, heat-up methods, cluster-assisted methods, microwave-assisted methods, and continuous-flow methods. In particular, quantum dots can be prepared according to: Lian et al. J. Am. Chem. Soc. 139, 8931-8938 (2017), which is herein incorporated by reference in its entirety.

In some embodiments, the quantum dots further comprise capping molecules on the surface of the quantum dots. Inclusion of capping molecules, such as surfactants or other ligands, can help tune the properties of the QDs, can help prevent agglomeration of the QDs in solution, and can provide charged moieties for electrostatic coupling of the QDs to a catalyst. Exemplary capping groups are described in, for example, Harris et al. Chem. Rev. 116, 12865-12919 (2016), which is herein incorporated by reference in its entirety. In some embodiments, the capping molecule includes an amine, a carboxylate, a thiol, or other functional group that binds to the QD surface. In particular embodiments, the capping molecule comprises a thiol that binds to the QD surface, and an amino group that can electrostatically couple to the CoTPPS catalyst. In some embodiments, the capping molecule is selected from 2-aminoethanethiol and 2-mercaptoethyl-N,N,N-trimethylammonium chloride. In some embodiments, the capping molecule is 2-aminoethanethiol. The capping molecule can be incorporated into the QDs in a ligand exchange reaction, exchanging ligands bound to the QDs as a result of their original synthesis (e.g., oleate ligands) with replacement ligands.

The QDs can be included in the reaction mixture at a concentration of about 1.0 μM to about 5.0 μM, or about 2.0 μM to about 4.0 μM, or about 2.0 μM to about 2.5 μM, e.g., about 0.10 μM, about 0.50 μM, about 1.0 μM, about 1.5 μM, about 2.0 μM, about 2.5 μM, about 3.0 μM, about 3.5 μM, about 4.0 μM, about 4.5 μM, or about 5.0 μM. In some embodiments, the QDs are present in the reaction mixture at a concentration of about 2.5 μM.

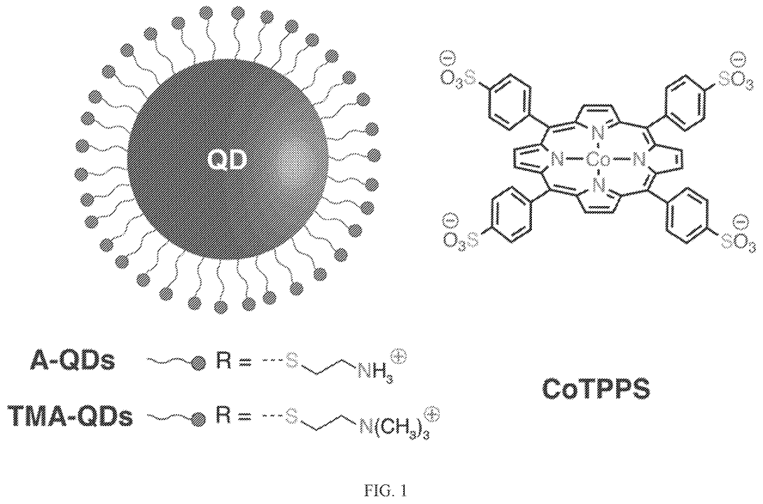

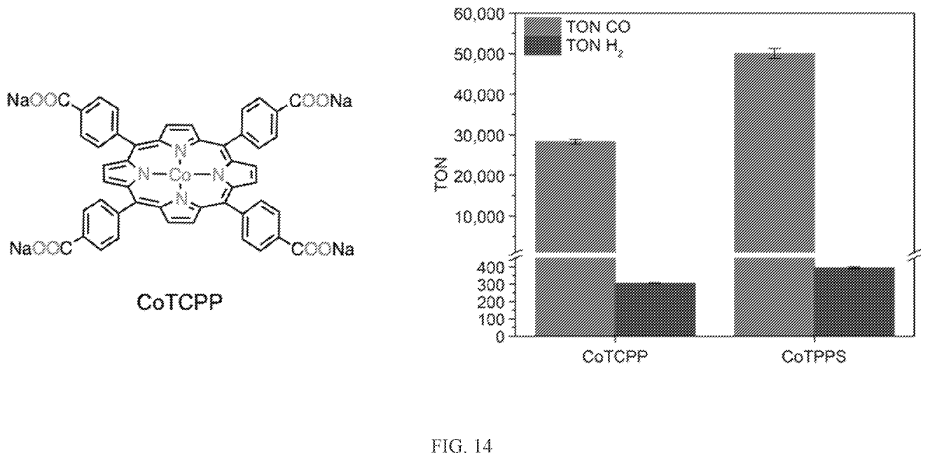

The reaction mixture also includes a cobalt(III) porphyrin compound, such as [{meso-tetra(4-sulfonatophenyl)porphyrinato}cobalt(III)] (CoTPPS) or [{meso-tetra(4-carboxyphenyl)porphyrinato}cobalt(III)] (CoTCPP), which is the catalyst for reduction of CO₂ to CO. The structure of CoTPPS is shown in FIG. 1, and the structure of CoTCPP is shown in FIG. 14. The QDs act as photosensitizers for the CoTPPS catalyst. CoTPPS has the structure illustrated below, and can be purchased from commercial sources or can be synthesized according to methods known in the art. For example, CoTPPS can be prepared according to: Call et al. ACS Catal. 9, 4867-4874 (2019), which is herein incorporated by reference in its entirety.

The CoTPPS can be included in the reaction mixture at a concentration of about 0.10 μM to about 2.0 μM, or about 0.1 μM to about 1.0 μM, or about 0.1 μM to about 0.50 μM, e.g., about 0.10 μM, about 0.15 μM, about 0.20 μM, about 0.25 μM, about 0.30 μM, about 0.35 μM, about 0.40 μM, about 0.45 μM, about 0.50 μM, about 0.55 μM, about 0.60 μM, about 0.65 μM, about 0.70 μM, about 0.75 μM, about 0.80 μM, about 0.85 μM, about 0.90 μM, about 0.95 μM, or about 1.0 μM. In some embodiments, the CoTPPS is present in the reaction mixture at a concentration of about 0.25 μM.

The reaction mixture also includes a reducing agent. Any water-soluble reducing agent with sufficient reducing potential can be used. In some embodiments, the reducing agent is sodium ascorbate, tris(2-carboxyethyl)phosphine, or a combination thereof. In some embodiments, the reducing agent is sodium ascorbate. The reducing agent can be present in the reaction mixture at a concentration of about 5 mM to about 100 mM, or about 10 mM to about 50 mM, e.g., about 5 mM, about 10 mM, about 15 mM, about 20 mM, about 25 mM, about 30 mM, about 35 mM, about 40 mM, about 45 mM, about 50 mM, about 50 mM, about 60 mM, about 65 mM, about 70 mM, about 75 mM, about 80 mM, about 85 mM, about 90 mM, about 95 mM, or about 100 mM. In some embodiments, the reducing agent is present in the reaction mixture at a concentration of about 5 mM. In some embodiments, the reducing agent is present in the reaction mixture at a concentration of about 25 mM. In some embodiments, the reaction mixture comprises a combination of reducing agents, and each reducing agent is present in the reaction mixture at a concentration of about 5 mM.

The reaction is carried out in water, which has minimal environmental impact compared to organic solvents, and also provides an opportunity to source electrons for CO₂ reduction from water oxidation. In some embodiments, the reaction is carried out in pure water with no added co-solvents or buffers. In some embodiments, the reaction mixture does not comprise an organic solvent, or is essentially free of an organic solvent (e.g., an organic solvent such as tetrahydrofuran, toluene, ethyl acetate, dichloromethane, chloroform, an ether such as diethyl ether, or the like). In some embodiments, the reaction mixture does not comprise a buffer. In some embodiments, the reaction mixture has a pH of about 5 to about 8, e.g., about 6 to about 7.

The method comprises adding carbon dioxide to the reaction mixture. Carbon dioxide can be added, for example, by replacing the gas in the headspace above the reaction mixture with carbon dioxide. In some embodiments, carbon dioxide can be bubbled through the reaction mixture. In some embodiments, the reaction mixture described above can be included in a reaction vessel, and carbon dioxide can be added to the reaction vessel, e.g., at a pressure of about 1 atm.

In some embodiments, the method comprises illuminating the mixture with light for about 18 hours to about 96 hours. For example, the mixture may be illuminated for about 18 hours, about 24 hours, about 30 hours, about 36 hours, about 48 hours, about 60 hours, about 72 hours, or about 96 hours, or any range therebetween. The light may be at a wavelength of about 450 nm. For example, in some embodiments, the method comprises illuminating the reaction mixture with a 450-nm light-emitting diode.

In some embodiments, the reactions are carried out in solution with the QDs, CoTPPS, and reducing agent in a vessel such as a flask, beaker, or chemical reactor (e.g., a research reactor, a commercial reactor, an industrial reactor, or the like). In some embodiments, the QDs are adhered to a surface (e.g., a reaction card, a plate, the interior surface of a volume (e.g., vial, chemical reactor, etc.), a chip, etc. and the other materials are passed over the surface.

In some embodiments, the reactor is of the appropriate scale for the particular application (e.g., <1 L, 1 L, 2 L, 5 L, 10 L, 20 L, 50 L 100 L, 200 L, 500 L, 1000 L, or more, or ranges therebetween). In some embodiments, a chemical reactor is a batch-style reactor, tank reactor, continuous stirred-tank reactor (CSTR), a plug flow reactor (e.g., with QDs adhered to the internal surface and liquid reagents passed through), a semi-batch reactor, etc. In some embodiments, a reactor comprises a window or translucent/transparent portion to allow illumination with the appropriate wavelength of light. In some embodiments, a reactor is transparent to the appropriate wavelength of light. In some embodiments, a reactor comprises an internal light source for illumination.

In some embodiments, the methods disclosed herein produce CO from CO₂ with a turnover number (TON) of more than 10000, e.g., more than 15000, more than 20000, more than 25000, more than 30000, more than 35000, more than 40000, more than 45000, more than 50000, more than 55000, more than 60000, more than 65000, more than 70000, more than 75000, or more than 80000. For example, in some embodiments, the methods disclosed herein produce CO from CO₂ with a TON of about 10000 to about 80000, or higher.

In some embodiments, the methods disclosed herein have a quantum yield of more than 0.5%, e.g., more than 1.0%, more than 1.5%, more than 2.0%, more than 2.5%, more than 3.0%, more than 3.5%, more than 4.0%, more than 4.5%, or more than 5.0%. For example, in some embodiments, the methods disclosed herein have a quantum yield of about 0.5% to about 5.5%, or higher.

In some embodiments, the methods disclosed herein produce CO with a selectivity of CO over H₂ (S_{CO}) of more than 95%, e.g., more than 95.5%, more than 96%, more than 96.5%, more than 97.0%, more than 97.5%, more than 98.0%, more than 98.5%, or more than 99.0%.

Without wishing to be limited by theory, the improved performance of methods disclosed herein is believed to be due primarily to: (i) electrostatic attraction of the QDs to the cobalt porphyrin catalyst, which promotes fast multielectron delivery (Lian et al. ACS Nano 12, 568-575 (2018)), and (ii) termination of the QD ligand shell with free amines, which pre-activate CO₂ as carbamic acid.

### Compositions

Also disclosed herein are compositions comprising a mixture of components that can be used for the photoreduction of CO₂ to CO. For example, disclosed herein is a composition comprising quantum dots, a cobalt(III) porphyrin compound (e.g., [{meso-tetra(4-sulfonatophenyl)porphyrinato}cobalt(III)] or [{meso-tetra(4-carboxyphenyl)porphyrinato}cobalt(III)]), a reducing agent, and water.

In some embodiments, the quantum dots in the composition are CuInS₂ quantum dots. In some embodiments, the quantum dots are core/shell quantum dots. For example, in some embodiments, the quantum dots have a CuInS₂ core and a ZnS shell. The QDs can be included in the composition at a concentration of about 1.0 μM to about 5.0 μM, or about 2.0 μM to about 4.0 μM, or about 2.0 μM to about 2.5 μM, e.g., about 0.10 μM, about 0.50 μM, about 1.0 μM, about 1.5 μM, about 2.0 μM, about 2.5 μM, about 3.0 μM, about 3.5 μM, about 4.0 μM, about 4.5 μM, or about 5.0 μM. In some embodiments, the QDs are present in the composition at a concentration of about 2.5 μM.

The cobalt(III) porphyrin compound (e.g., CoTPPS or CoTCPP) can be included in the composition at a concentration of about 0.10 μM to about 2.0 μM, or about 0.1 μM to about 1.0 μM, or about 0.1 μM to about 0.50 μM, e.g., about 0.10 μM, about 0.15 μM, about 0.20 μM, about 0.25 μM, about 0.30 μM, about 0.35 μM, about 0.40 μM, about 0.45 μM, about 0.50 μM, about 0.55 μM, about 0.60 μM, about 0.65 μM, about 0.70 μM, about 0.75 μM, about 0.80 μM, about 0.85 μM, about 0.90 μM, about 0.95 μM, or about 1.0 μM. In some embodiments, the cobalt(III) porphyrin compound (e.g., CoTPPS or CoTCPP) is present in the composition at a concentration of about 0.25 μM.

The composition also includes a reducing agent. In some embodiments, the reducing agent is sodium ascorbate, tris(2-carboxyethyl)phosphine, or a combination thereof. The reducing agent can be present in the composition at a concentration of about 5 mM to about 100 mM, or about 10 mM to about 50 mM, e.g., about 5 mM, about 10 mM, about 15 mM, about 20 mM, about 25 mM, about 30 mM, about 35 mM, about 40 mM, about 45 mM, about 50 mM, about 50 mM, about 60 mM, about 65 mM, about 70 mM, about 75 mM, about 80 mM, about 85 mM, about 90 mM, about 95 mM, or about 100 mM. In some embodiments, the reducing agent is present in the composition at a concentration of about 5 mM. In some embodiments, the reducing agent is present in the composition at a concentration of about 25 mM. In some embodiments, the composition comprises a combination of reducing agents, and each reducing agent is present in the composition at a concentration of about 5 mM.

The composition further comprises water. In some embodiments, the composition comprises pure water with no added co-solvents or buffers. In some embodiments, the composition does not comprise an organic solvent, or is essentially free of an organic solvent (e.g., an organic solvent such as tetrahydrofuran, toluene, ethyl acetate, dichloromethane, chloroform, an ether such as diethyl ether, or the like). In some embodiments, the composition has a pH of about 5 to about 8, e.g., about 6 to about 7.

In some embodiments, the composition further comprises carbon dioxide.

The following examples further illustrate aspects of the disclosure but, of course, should not be construed as in any way limiting its scope.

### EXAMPLES

The following abbreviations are used in the Examples: “bpy” means bipyridine; “NaAsc” means sodium ascorbate; “PTFE” means polytetrafluoroethylene; “QDs” means quantum dots; and “TCEP” means tris(2-carboxyethyl)phosphine.

Materials and Synthesis. NaAsc (Spectrum Chemical, 99%), tris(2,2′-bipyridyl)dichlororuthenium(II) hexahydrate (Sigma-Aldrich, powder) and 2-aminoethanethiol hydrochloride (Sigma-Aldrich, 98%) were used as received. TCEP (TCI Chemicals, >98%) was stored under N₂ at −20° C. CoTPPS, 2-mercaptoethyl-N,N,N-trimethylammonium chloride and oleate-capped CuInS₂/ZnS core/shell QDs were synthesized according to previously reported procedures (Call et al. ACS Catal. 9, 4867-4874 (2019); Lian et al. J. Am. Chem. Soc. 139, 8931-8938 (2017); Chalker et al. Angew. Chem. Int. Ed. 51, 1835-1839 (2012)). In a typical ligand exchange procedure, 0.8 mmol of 2-mercaptoethyl-N,N,N-trimethylammonium chloride or 2-aminoethanethiol hydrochloride (98%, Sigma Aldrich) in 2.0 mL of Milli-Q water were added to 0.0003 mmol of oleate-capped QDs in 4.0 mL of chloroform in a 15 mL centrifuge tube. The centrifuge tube was shaken for several minutes and the sample was centrifuged for 10 mM at 7,000 rpm. The aqueous layer was washed with chloroform.

Herein, the 2-aminoethanethiol capped CuInS₂/ZnS core/shell QDs are referred to as “A-QDs” and the 2-mercaptoethyl-N,N,N-trimethylammonium capped 2-mercaptoethyl-N,N,N-trimethylammonium are referred to as “TMA-QDs.”

QDs Characterization. Absorption and fluorescence spectra were collected on a Varian Cary 5000 spectrometer and a Fluorolog-3 spectrofluorometer (Horiba Jobin Yvon). The pKₐ was determined from a pH titration (0.1 M aq. NaOH) of a 29.1 μM A-QDs aqueous solution

NMR Characterization. NMR spectra were acquired using a Bruker Avance III 500 MHz spectrometer with DCH cryoprobe. A 0.50 mL solution of QDs was placed in low pressure/vacuum NMR tube (500 MHz) first placed under house vacuum, then backfilled with ¹³CO₂ (Sigma Aldrich) and sealed. To determine the reversibility of CO₂ capture, a QDs solution (0.2 mM, 2.5 mL, pH 6.2, H₂O/D₂O 9:1 v/v) in a photocatalysis vial was subjected to three freeze-pump-thaw cycles, backfilled with He, followed by bubbling ¹³CO₂ (99%, Sigma-Aldrich, 10 L) for 5 minutes (flow rate 5 mL·min⁻¹). ¹³CO₂→He had the solution further purged with He (flow rate 20 mL·min⁻¹) for 5, 10 or 15 minutes before transferring (0.55 mL each time) to previously degassed NMR tube.

Samples without sodium ascorbate were prepared using A-QDs (2.5 μM in D₂O) and CoTPPS (0.25 μM in D₂O) at pH 6.2, purged with Ar (5 mM) and CO₂ (10 min) and irradiated for 18 hours. ¹H and ¹³C NMR (500 MHz and 126 MHz, respectively) were recorded before and after irradiation and were compared to a sample kept in the dark for the same amount of time. 2-Aminoethanethiol hydrochloride (˜5 mM, D₂O) and 2,2′-diaminodiethyl disulfide dihydrochloride (Sigma-Aldrich, 96%, ˜5 mM, D₂O) were prepared and used as standards.

### Example 1: Photocatalytic Reactions and Chromatographic Detection of Gases

Photocatalytic reactions. Samples were prepared in a 9.0 mL screw cap vial equipped with a micro stir bar and closed with silicone/PTFE septum. Vials were sealed and purged for 5 minutes with Ar, followed by 10 minutes with CO₂ by using steel needles as inlet (inserted through the cap inside the solution) and outlet (to the headspace). The pressure of CO₂ in the headspace was then equilibrated to 1 atm. The vials were then illuminated using a homebuilt photoreactor made of royal blue (450 nm) LEDs (Cree XLamp XP-E2 Color High Power LED Star, LEDsupply.com) with a light intensity of 140 mW·cm⁻² (measured using an Optical Power Meter PM100D with Optical Sensor S120VC from Thorlabs). Each vial was suspended on top of a single LED, equipped with a lens, using a homebuilt sample holder.

Chromatographic Detection of Gases. Analyses of gases evolved in the headspace during the photocatalysis were performed with a custom-built Shimadzu GC-2014 gas chromatography system equipped with a thermal conductivity and flame ionization detector. H₂, CO, and CH₄ production was quantitatively detected using HayeSep T ( 1/16″, 7.5 m) and MS-5A ( 1/16″, 2.5 m) columns The temperature was held at 100° C. for the detector and 55° C. for the oven. The carrier gas was argon flowing at 8.5 mL/min, at constant pressure of 3.8-4.0 bars. Injections (150 μL) were performed via an autosampler equipped with a gas-tight syringe. Calibration curves for H₂, CO and CH₄ were collected by injecting known quantities of H₂ (5% standard), CO (pure) and CH₄ (4% standard). Experiments were performed at least twice each. In case of A-QDs and TMA-QDs samples, the vials were purged with Ar and CO₂ after each injection, in order to keep the amount of CO within the range of the calibration curve. Freeze-pump-thaw experiments were performed using the same solutions and vials before backfilling with Ar and irradiating the samples.

GC-MS were performed on an Agilent Technologies 6850 Network GC system coupled with a 5975C VL MSD with Triple-Axis Detector. The GC was equipped with a HP-PLOT Q column, the oven temperature was kept at 35° C., the inlet temperature was 250° C., the He carrier gas flow was 1.0 mL·min⁻¹ at a pressure of 2.30 psi. Headspace samples (500 μL) were manually injected. The samples contain 2.5 μM A-QDs, 1.0 μM CoTPPS and 25 mM NaAsc in H₂O (pH 6.2) and were prepared by performing three freeze-pump-thaw cycles, backfilled by He, followed by bubbling either CO₂ (99.9%, Airgas) or ¹³CO₂ (99%, Sigma-Aldrich, 10 L) for 5 minutes (flow rate 5 mL·min⁻¹). CO₂→He samples were further purged with He (20 mL·min⁻¹) until there was no CO₂ present in the headspace (the solution was purged for 10 minutes, followed by 30-35 minutes of headspace purging). We extracted the m/z=12 and 13 ion chromatograms because air (N₂ with m/z=28 and 29) had similar retention times of CO.

### Example 2: Measurement of Quantum Yields, Turnover Frequencies and Sensitization Efficiencies

The quantum yield (Φ_{CO}) of the process is defined as the number of defined events occurring per photon absorbed by the system at a specific wavelength (following a IUPAC report and a recent dedicated review; Qureshi et al. Chem. Mater. 2017, 29, 158-167; Braslaysky et al. Pure Appl. Chem. 2011, 83, 931-1014), and was calculated according to the following equation (Call et al. ACS Catal. 9, 4867-4874 (2019); Geletii et al. J. Am. Chem. Soc. 131, 7522-7523 (2009)):

$${Φ}_{CO} = \frac{number of CO molecules \times 2}{number of photons absorbed} \times 100$$

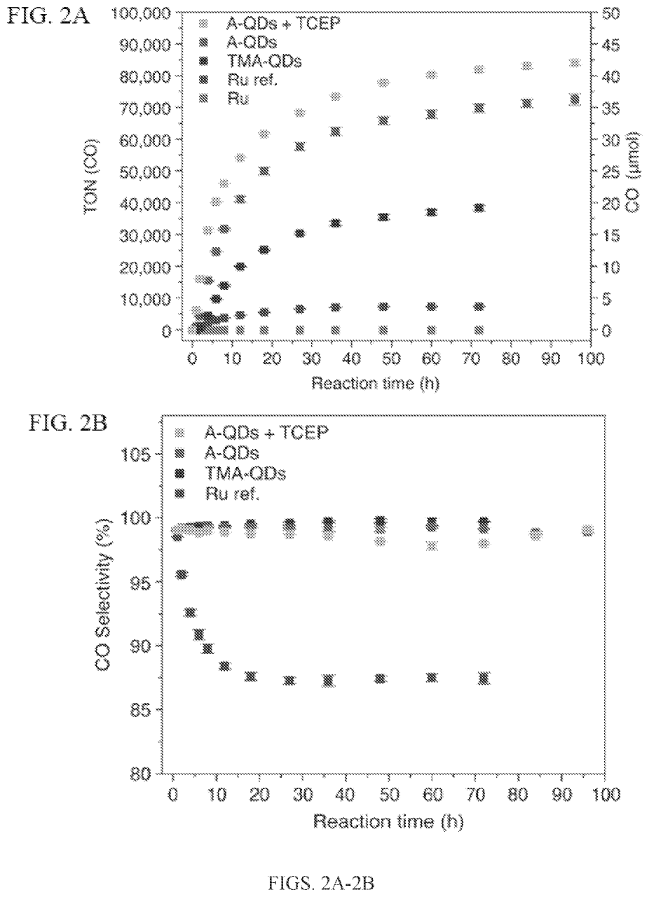

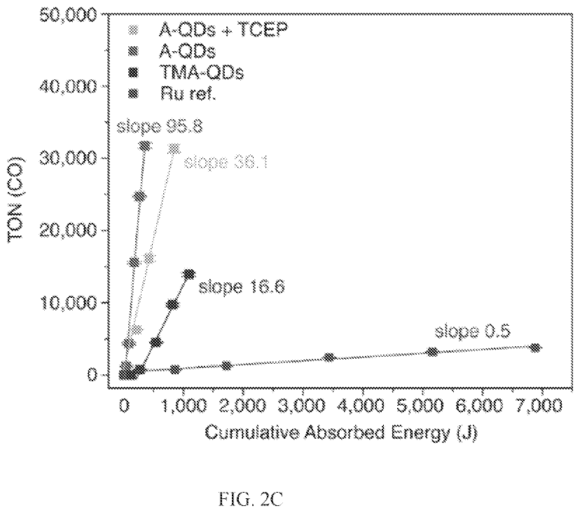

The sensitization efficiency (the number of CO molecules produced per joule of absorbed photon energy per catalyst molecule) is the slope of the curve in FIG. 2c, where the cumulative absorbed photon energy (J) was calculated according to the following equation (Lian et al. J. Am. Chem. Soc. 139, 8931-8938 (2017)):

$$Cumulative absorbed photon energy ( J ) = light intensity ( 0.14 \frac{J}{s \times {cm}^{2}} ) \times illumination area ( 1.767 {cm}^{2} ) \times time ( s ) \times fraction of photons absorbed$$

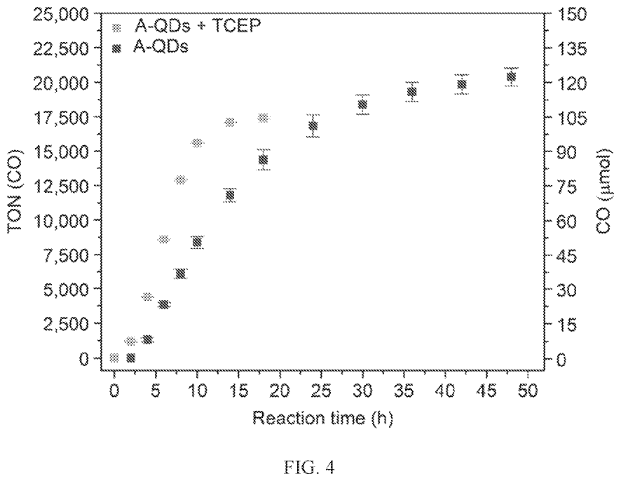

To calculate the fraction of photons absorbed, the amount of absorbed light was determined at the beginning of the photocatalytic experiments from (at least) three independent readings of the measured power at the top of the reaction vessel (uncertainty ≤5%, an Optical Power Meter PM100D with Optical Sensor S120VC from Thorlabs was used). The reaction vessel contained a 2.0 mL solution of NaAsc (or NaAsc and TCEP) to account for the reflection loss at the glass/air interface. The number of photons absorbed was calculated taking the photon wavelength equal to 450 nm, an incident light power of 140 mW·cm⁻² and considering an illuminated area of 1.767 cm². Under the current conditions, the samples containing QDs absorbed 23% or 5% (with or without TCEP) and 19% or 7% (with or without TCEP) of incident photons for 0.25 μM and 2.5 μM CoTPPS added, respectively, while the 500 μM [Ru(bpy)₃]²⁺ sample absorbed 100% of incident photons. The number of molecules of CO and the turnover number for CO were determined from the moles of CO in the sample headspace (obtained by GC measurements) from three independent experiments with uncertainty ≤5% (the quantum yields are reported at 2 h of irradiation; CO production, shown in FIGS. 2A and 4, and, consequently, quantum yield decreases at long illumination time. For example, after 8 h of irradiation the QYs are 4.63% for A-QDs+2.5 μM CoTPPS without TCEP, 2.92% for A-QDs+2.5 μM CoTPPS with TCEP, 2.44% for A-QDs+0.25 μM CoTPPS without TCEP, and 0.75% for A-QDs+0.25 μM CoTPPS with TCEP). The maximum turnover frequency for CO, defined as turnover number for CO/reaction time, was determined from FIG. 6.

### Example 3: Electrochemical Characterization

Cyclic voltammetry (CV) was performed on a CHI660D potentiostat at room temperature, employing a standard three-electrode single-compartment cell: glassy carbon electrode (GCE, CH Instruments, d=3 mm) as working electrode, a Pt wire as counter electrode and Ag/AgCl (3M KCl) as reference electrode. Working and reference electrodes were polished on a felt pad with 0.3 or 0.05 μm Al₂O₃ suspensions, sonicated in deionized water for about 30 seconds and washed/dried before each experiment; the Pt wire was flame-cleaned. A blank scan was recording before each sample (scan rate=50 mV·s⁻¹). CoTPPS was dissolved in Milli-Q H₂O (0.5 mM, 0.1 M KCl as supporting electrolyte), the pH was adjusted to 6.5 (1 M aq. NaOH) and degassed with Ar for 15 minutes. After recording the CV scan (scan rate was 50 mV·s⁻¹), the same solution was purged with CO₂ (99.9%, Airgas). After another scan, either the QDs (final concentration=1.2 μM) or ligands (final concentration=0.5 mM) were added, the solution was further purged with CO₂ and the pH was checked again.

### Results and Discussion

Data collected according to the procedures described in Examples 1-3 are presented in Tables 1 and 2. In Table 1, the pH measured before bubbling gas was 6.0-6.2 for entries 1-6 and 8.4 for entry 7. In Table 2, the pH was measured before bubbling gas, and the gas was sampled only once at 18 h (and 36 h). The uncertainty for TON values is ≤5%.

TABLE 1
Photocatalytic Performance for Various Sensitizers and Conditions

| | | | Reaction | | | | | | |
|---|---|---|---|---|---|---|---|---|---|
| | CoTPPS | Sensitizer | conditions | Time | TON | | | S_{CO} | QY_{CO} |
| Entry | (μM) | (μM) | (mM) | (h) | CO | CH₄ | H₂ | (%) | (%)^{†} |
| 1 | 0.25 | A-QDs (2.5) | NaAsc (25) | 96 | 72,494 | — | 602 | 98.9 | 3.39 |
| 2 | 2.5 | A-QDs (2.5) | NaAsc (25) | 48 | 20,379 | — | 119 | 99.4 | 5.23 |
| 3 | 0.25 | A-QDs (2.5) | NaAsc (5) + | 96 | 84,101 | — | 1,011 | 99.1 | 0.96 |
| | | | TCEP (5) | | | | | | |
| 4 | 2.5 | A-QDs (2.5) | NaAsc (5) + | 18 | 17,406 | 107 | 112 | 99.7 | 3.53 |
| | | | TCEP (5) | | | | | | |
| 5 | 0.25 | TMA-QDs (2.5) | NaAsc (25) | 72 | 38,473 | — | 220 | 99.7 | 0.53 |
| 6 | 0.25 | [Ru(bpy)₃]²⁺ (12) | NaAsc (25) | 72 | — | — | 16 | — | — |
| 7 | 0.25 | [Ru(bpy)₃]²⁺ (500) | NaAsc (100) + | 72 | 7,398 | — | 1,063 | 87.4 | 0.06^{‡} |
| | | | NaHCO₃ (100) | | | | | | |

^{†}QYs are measured from the moles of CO produced over 2 h of irradiation, and are the average of three independent experiments (see Methods). The pH measured before bubbling gas is 6.0-6.2 for entries 1-6 and 8.4 for entry 7.
^{‡}The optimized QY reported in a prior reference (Call et al. ACS Catal. 9, 4867-4874 (2019)) is 0.81%.

TABLE 2
Photocatalytic Performance for the A-QD-CoTPPS system

| | | | | Reaction | | | | | | |
|---|---|---|---|---|---|---|---|---|---|---|
| | | CoTPPS | A-QDs | conditions | | Time | TON | | | S_{CO} |
| Entry | Gas | (μM) | (μM) | (mM) | pH | (h) | CO | CH₄ | H₂ | (%) |
| 1 | CO₂ | 0.25 | 2.5 | NaAsc (25) | 6.2 | 18 | 50,017 | — | 394 | 99.2 |
| 2 | CO₂ | 0.25 | 2.5 | NaAsc (25) | 6.2 | 36 | 62,468 | — | 507 | 99.1 |
| 3 | CO₂ | 0.25 | 2.5 | NaAsc (25) + | 6.2 | 18 | 49,897 | — | 155 | 99.7 |
| | | | | Hg⁰ (12.5) | | | | | | |
| 4 | CO₂ | 0.25 | 2.5 (×2) | NaAsc (25) | 6.2 | 36 | 90,050 | — | 387 | 99.6 |
| 5 | CO₂ | 0.25 (×2) | 2.5 | NaAsc (25) | 6.2 | 36 | 79,484 | — | 336 | 99.6 |
| 6 | CO₂ | 0.25 | 2.5 | NaAsc (25) (×2) | 6.2 | 36 | 69,759 | — | 283 | 99.6 |
| 7 | CO₂ | 0.25 (×2) | 2.5 (×2) | NaAsc (25) | 6.2 | 36 | 102,548 | — | 436 | 99.6 |
| 8 | CO | 0.25 | 2.5 | NaAsc (25) | 6.2 | 18 | — | ^{♦} | 40 | 85.0 |
| 9 | CO | — | 2.5 | NaAsc (25) | 6.2 | 18 | — | ^{♦♦} | ^{♦♦♦} | 98.4 |
| 10 | CO₂ | — | 2.5 | NaAsc (25) | 6.2 | 18 | — | — | ‡ | — |
| 11 | CO₂ | 0.25 | 2.5 | — | 6.1 | 18 | 2,394 | — | 37 | 98.4 |
| 12 | CO₂ | 0.25 | 2.5^{#} | — | 6.1 | 18 | — | — | 8 | — |
| 13 | CO₂ | 0.25 | — | NaAsc (25) | 6.2 | 18 | — | — | — | — |
| 14 | Ar | 0.25 | 2.5 | NaAsc (25) | 6.2 | 18 | 3,852 | — | 423 | 90.1 |
| 15 | ^{§}Ar | 2.5 | 2.5 | NaAsc (25) | 6.2 | 18 | — | — | 294 | — |
| 16 | 75% CO₂ | 0.25 | 2.5 | NaAsc (25) | 6.2 | 18 | 48,069 | — | 195 | 99.6 |
| 17 | 50% CO₂ | 0.25 | 2.5 | NaAsc (25) | 6.2 | 18 | 31,185 | — | 181 | 99.4 |
| 18 | 25% CO₂ | 0.25 | 2.5 | NaAsc (25) | 6.2 | 18 | 21,957 | — | 172 | 99.2 |
| 19 | 10% CO₂ | 0.25 | 2.5 | NaAsc (25) | 6.2 | 18 | 9,593 | | 300 | 98.0 |
| 20 | CO₂ | 0.25 | 2.5 | NaAsc (25) + | 7.5 | 18 | 31,610 | — | 292 | 99.1 |
| | | | | NaHCO₃ (25) | | | | | | |
| 21 | CO₂ | 0.25 | 2.5 | NaAsc (25) + | 6.2 | 18 | 1,767 | — | 40 | 97.8 |
| | | | | DHA (25) | | | | | | |
| 22 | CO₂ | 0.5 | 15 | NaAsc (100) | 6.1 | 18 | 20,588 | — | 561 | 97.4 |
| 23 | CO₂ | 0.5 | 15 | NaAsc (100) | 7.0 | 18 | 22,394 | — | 507 | 97.7 |

^{♦} 1.1 μmol of CH₄.
^{♦♦} 1.25 μmol of CH₄.
^{♦♦♦} 20.9 nmol of H₂.
‡ 18.5 nmol of H2.
^{#}QDs were crashed from the aqueous layer with acetone and resuspended in Milli-Q water; this stock solution was used for the preparation of the photocatalytic mixture.
^{§}The catalytic mixture was subjected to three freeze-pump-thaw cycles before backfilling with Ar. Entries 4-7: Re-addition of the initial amount of A-QDs or NaAsc or CoTPPS to the catalytic mixture after 18 h illumination and illumination for further 18 h. Entries 16-19: The catalytic mixture was purged with CO₂ 75-10 vol. %, Ar balanced by using rotameters and checked with ADM flow meter (Agilent).

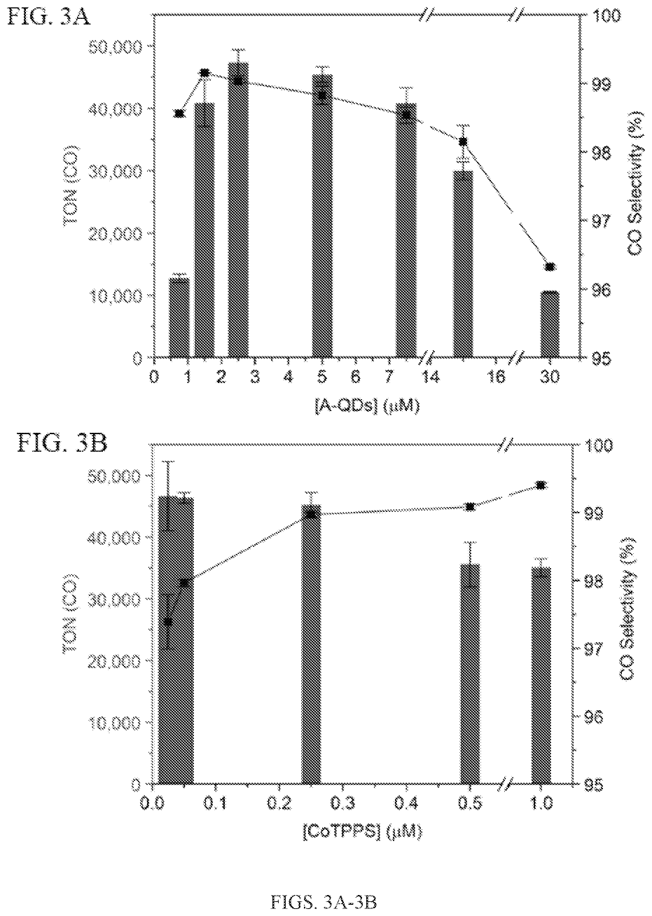

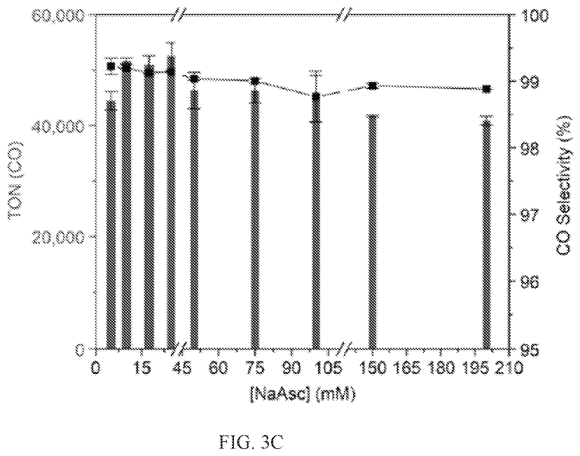

Reaction mixtures without QDs yielded no photoreduction products; trace H₂ (18.5 nmol) was detected in the absence of CoTPPS (Table 2). Before bubbling CO₂, the pH of the reaction mixture was between 6 and 7, and the catalytic activity was not dependent on the pH in this range (Table 2). In prior work, CO₂ reduction systems were optimized by adjusting the pH with addition of salts, but addition of NaHCO₃, which served as a pH buffer in the best reported system (Call et al. ACS Catal. 9, 4867-4874 (2019)), decreased the activity in these systems (Table 2) probably by deprotonating the terminal amines and thereby destabilizing the colloidal suspension. FIGS. 3A-3C summarize the optimization of this system with respect to concentrations of sensitizer, catalyst, and NaAsc. Under the current optimal composition of the reaction mixture of 2.5 μM A-QDs, 0.25 μM CoTPPS and 25 mM NaAsc, an 18-h illumination produced CO with TON=50,017 and S_{CO}=99.1% over H₂ evolution with a maximum TOF=4,114 h⁻¹ (FIG. 6). Analysis of the liquid phase by ¹H NMR detected no other products.

FIG. 2A shows the generation of CO by the optimized systems containing A-QDs and TMA-QDs as a function of irradiation time. A-QDs and TMA-QDs produced CO selectively (99%) with TON (quantum yield, QY) of 72,494 (3.4%) and 38,473 (0.53%), respectively (Table 1, entries 1 and 5; FIGS. 2A-2B). The QY for the photocatalytic production of CO was improved to 5.2% by increasing the concentration of CoTPPS from 0.25 μM to 2.5 μM for the system containing A-QDs, with the selectivity for CO over H₂ remaining >99%, (Table 1, entry 2 and FIG. 4). During this reaction, methane is produced, suggesting that enough CO accumulates to be further reduced (Table 1, entry 2) (Rao et al. Nature 548, 74-77 (2017)). Further increase of the CoTPPS concentration will likely result in its parasitic light absorption by the catalyst. The QY of 5.2% with single-wavelength excitation is among the highest reported to date for CO production in water. This parameter is important for assessing a system's potential for technology development: a solar-to-fuel conversion efficiency of 10% is considered to be the minimum performance required for photocatalysis to be an economically viable resource.

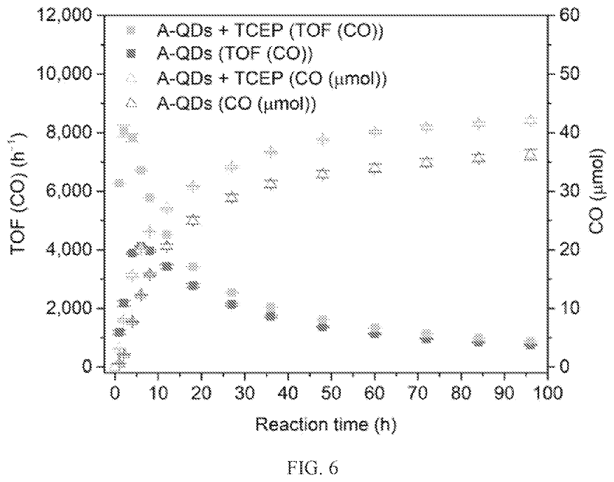

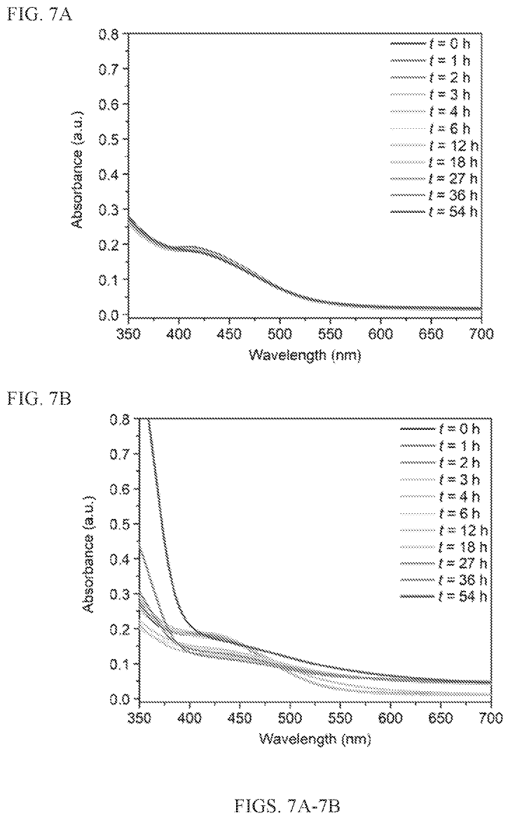

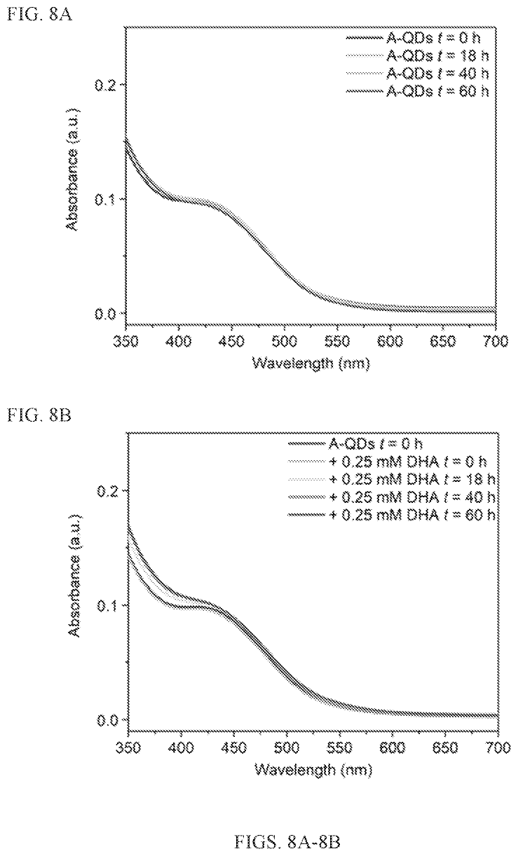

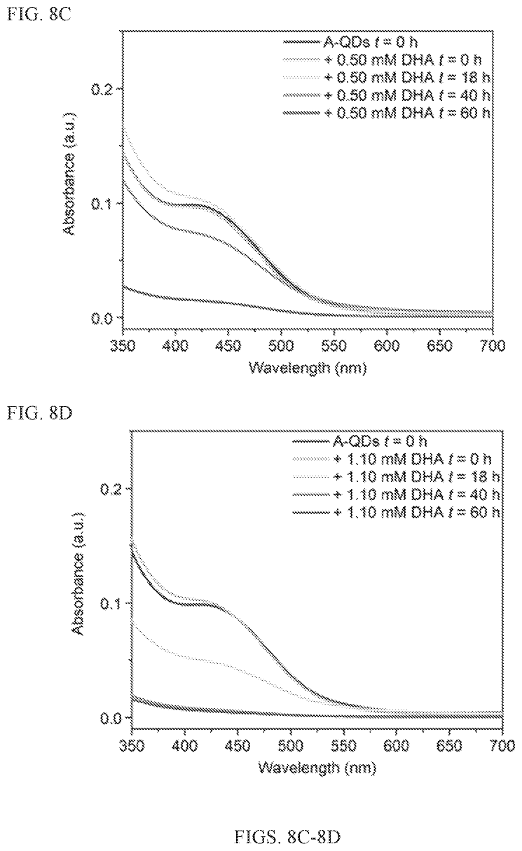

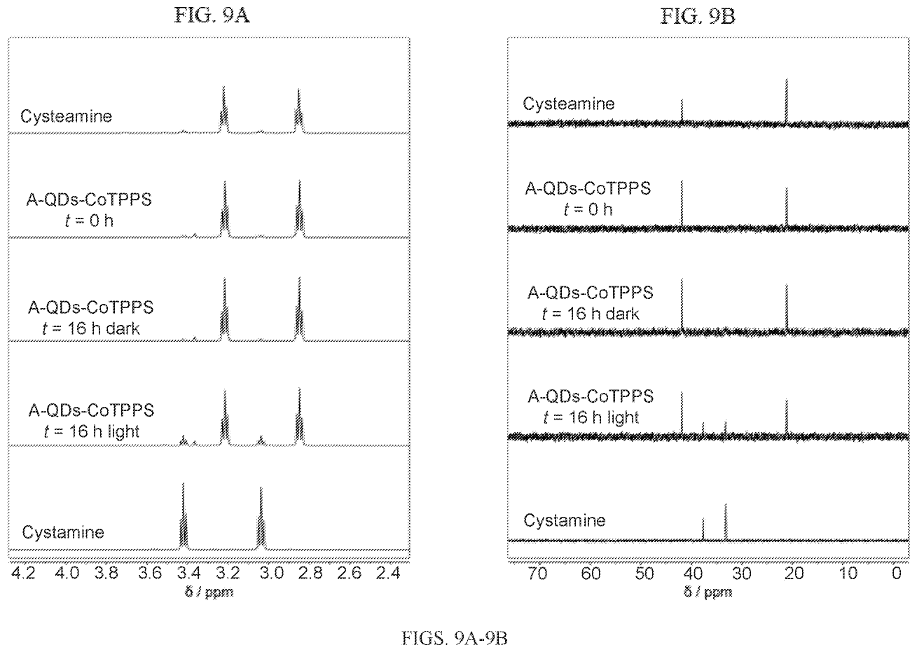

When combination of tris(carboxyethyl)phosphine (TCEP) and NaAsc as a sacrificial donor was used, the TON for CO further increases to 84,101 while maintaining a selectivity of >99% with a maximum TOF=8,063 h⁻¹ (Table 1 (entry 3), FIGS. 2A-2B, FIG. 6). TCEP is known to continuously reduce the dehydroascorbic acid (DHA) to NaAsc and thereby suppress inhibition of photocatalysis by DHA (Martindale et al. Angew. Chem. Int. Ed. 55, 9402-9406 (2016)). The data in FIGS. 7A-7B, FIGS. 8A-8D, and Table 2 confirm that re-addition of the initial amount of QDs restores catalysis (more so than does the re-addition of the initial amount of CoTPPS or of NaAsc), and that accumulation of DHA during prolonged illumination of the reaction mixture, or direct addition of DHA to the reaction mixture, encourages precipitation of the QDs and halts catalysis. In the absence of a sacrificial donor, the A-QDs-CoTPPS system yields CO selectively, with a TON of 2,394 after 18 h (Table 2). NMR spectra of the catalytic mixture before irradiation include two triplets corresponding to the excess ligand (2-aminoethanethiol). After irradiation, two new triplet peaks appear, attributable to the oxidized form of the ligand, 2,2′-diaminodiethyl disulfide (FIGS. 9A-9B). When excess ligand is not present, the same catalytic system yielded no CO (Table 2). These results show that aminoethanethiol acts as the primary hole scavenger in the absence of ascorbate.⁵³

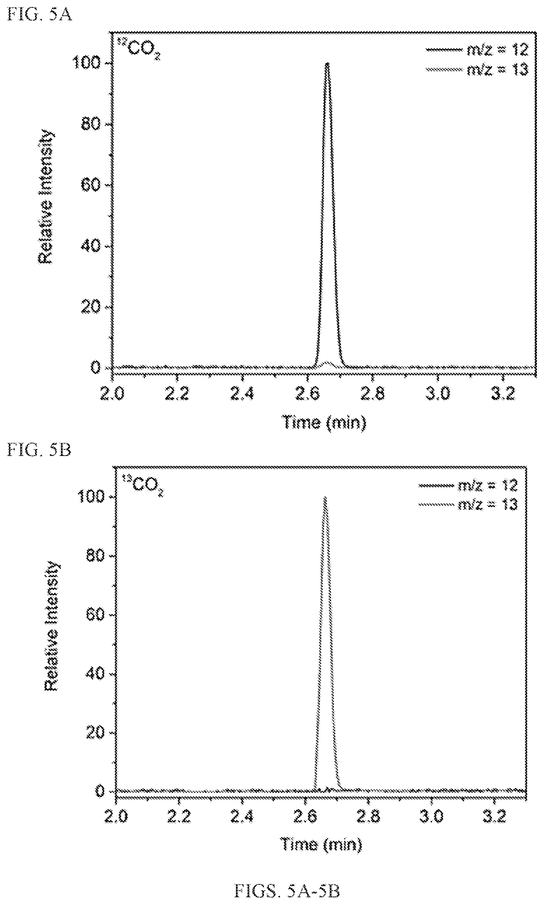

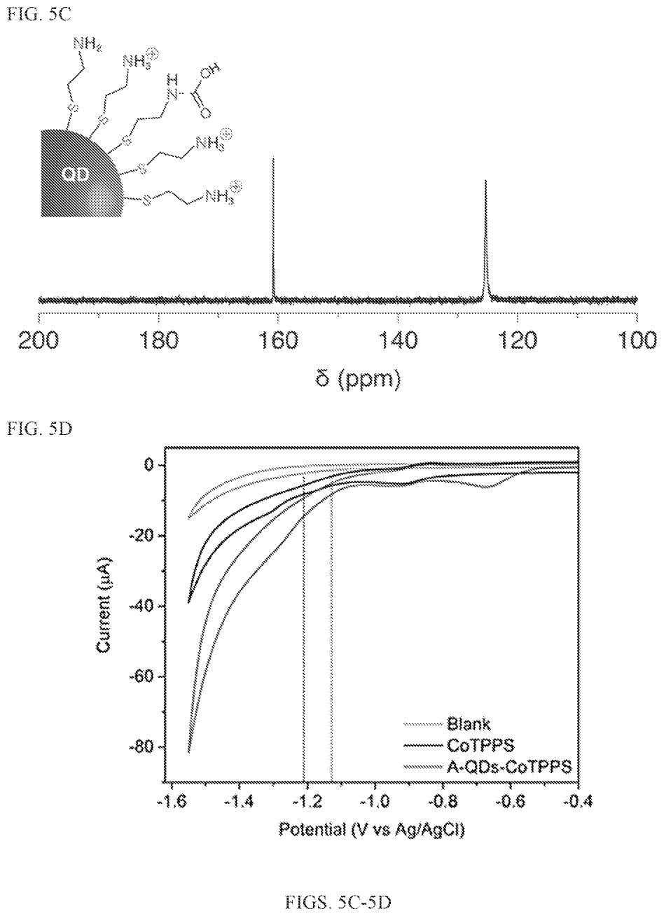

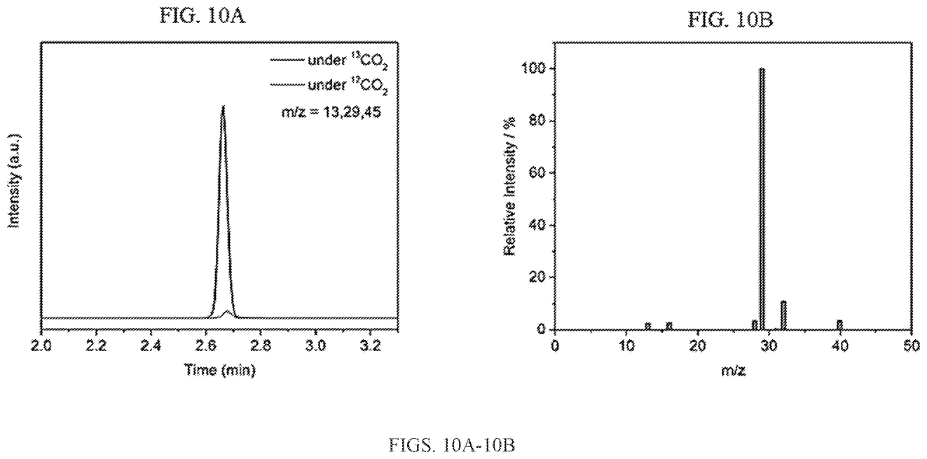

Photocatalytic experiments for the A-QD-CoTPPS system were repeated on samples that underwent three freeze-pump-thaw cycles (completely removing all CO₂ from the system) before bubbling either ¹³CO₂ or CO₂. GC-MS analysis of product shows that peaks from CO and ¹³CO are exchanged when CO₂ substrate was switched to ¹³CO₂ (FIGS. 5A-5B and FIGS. 10A-10B), providing an unambiguous confirmation that CO originates from CO₂ reduction (Boutin et al. Trends Chem. 2021, 3, 359-372.

The optimized QY of the A-QD system (QY=5.2%) is a factor of 6.4 higher than the optimized value in the benchmark report, which uses a combination of a [Ru(bpy)₃]²⁺ sensitizer and the CoTPPS catalyst (Call et al. ACS Catal. 9, 4867-4874 (2019)). The optimized TON of the A-QD system (TON=84,101 with S_{CO}=99%) is a factor of 91 higher than the optimized value in the benchmark report (TON=926 with S_{CO}=82%), even though the concentration of QDs is a factor of 200 lower than that of [Ru(bpy)₃]²⁺.

In the [Ru(bpy)₃]²⁺-CoTPPS system, the TON is sensitive to catalyst concentration: TON increases from 926 to ca. 4,000 upon decreasing [CoTPPS] from 10 μM (S_{CO}=82%) to 0.5 μM (S_{CO}=41%). The performance of the QD-CoTPPS system was therefore directly compared to that of the [Ru(bpy)₃]²⁺-CoTPPS system using two different [Ru(bpy)₃]²⁺ reaction mixtures. Both mixtures had the same concentration of the catalyst (0.25 μM CoTPPS) used in the QD system. System 1 had 12 μM [Ru(bpy)₃]²⁺, which is the concentration that has the same absorbance as the QDs (2.5 μM) at the excitation wavelength for the reaction, 450 nm. System 2 used the optimized conditions of the benchmark report (Call 2019): 500 μM of [Ru(bpy)₃]²⁺ in an aqueous bicarbonate buffer. System 1 produced no CO and only a trace amount of H₂ (Table 1, entry 6 and FIG. 2A). System 2 produced CO with a TON of 7,398 at the longest irradiation time of 72 h (Table 1, entry 7 and FIG. 2A). Even given optimization of the [Ru(bpy)₃]²⁺ system, the TON for A-QD-CoTPPS is more than a factor of ten higher than that of [Ru(bpy)₃]²⁺-CoTPPS, even though the concentration of QDs is a factor of 200 lower than that of [Ru(bpy)₃]²⁺. Furthermore, the QD systems produce CO with a selectivity of ˜99% for the entire illumination time (up to 96 h), while, for the [Ru(bpy)₃]²⁺ system, the selectivity drops to 87.4% (Table 1, entry 7 and FIG. 2B).

FIG. 2C shows the sensitization efficiency, ξ—defined as the molecules of CO produced per J of absorbed photon energy—for the three QD-sensitized systems and the [Ru(bpy)₃]²⁺-sensitized system. This parameter allows us to compare photocatalytic systems that use different excitation powers and illumination times, or, as in this case, different absorptivities of their sensitizers. ξ for the A-QDs is a factor of nearly 200 greater than ξ for [Ru(bpy)₃]²⁺ when the concentration of CoTPPS is held constant (Table 1, entry 7), and ξ for the A-QDs is a factor of ten greater than ξ for [Ru(bpy)₃]²⁺ using the optimized conditions from the benchmark study (Call 2019). In the nano-confined environment of the QD surface, the pKₐ of the terminal amine of aminoethanethiol (the ligand for the A-QDs) drops from ˜10 to ˜6 (see the Experimental section above). Consequently, only ca. 50% of the A-QD ligands have a terminal positive charge at the pH of our reaction mixture (6.0-6.2), while the remaining ligands of the A-QDs are present as free amines While the decrease in positive charge of the A-QDs decreases the number of CoTPPS molecules that adsorb to their surfaces relative to the fully charge TMA-QDs in CO₂-purged water, the TON of CO is nearly a factor of two higher for the A-QDs than for the TMA-QDs. These results show that the electrostatic assembly of sensitizer and catalyst is not the sole reason for the exceptional performance of the QD-CoTPPS system. The possible influence of the terminal amine of the A-QDs on this reaction was therefore examined.

The terminal amines of the A-QDs reversibly trap CO₂ as a carbamic acid precursor to CO. The ¹³C NMR spectrum of an aqueous solution of A-QDs at pH 6.1 and bubbled with ¹³CO₂ shows a resonance at 160.8 ppm (FIG. 5C), which coincides with resonances reported previously for carbamic acid formed upon complexation of CO₂ with amines, and a resonance at 125.3 ppm corresponding to dissolved CO₂. The formation of the carbamic acid is consistent with the pKₐ of the terminal amine of the A-QDs. If the pKₐ of an amine is above ˜5, it will react with CO₂ at ambient pressure and temperature in aqueous solution without promoters. The amines on the A-QDs should therefore be capable of reacting with CO₂ under our conditions, but as weakly basic amines, i.e. amines basic enough to bond with CO₂ as carbamic acid (with a weak N—C) bond, but not basic enough to form carbamate (with a strong N—C bond) at the pH of our reaction mixture.

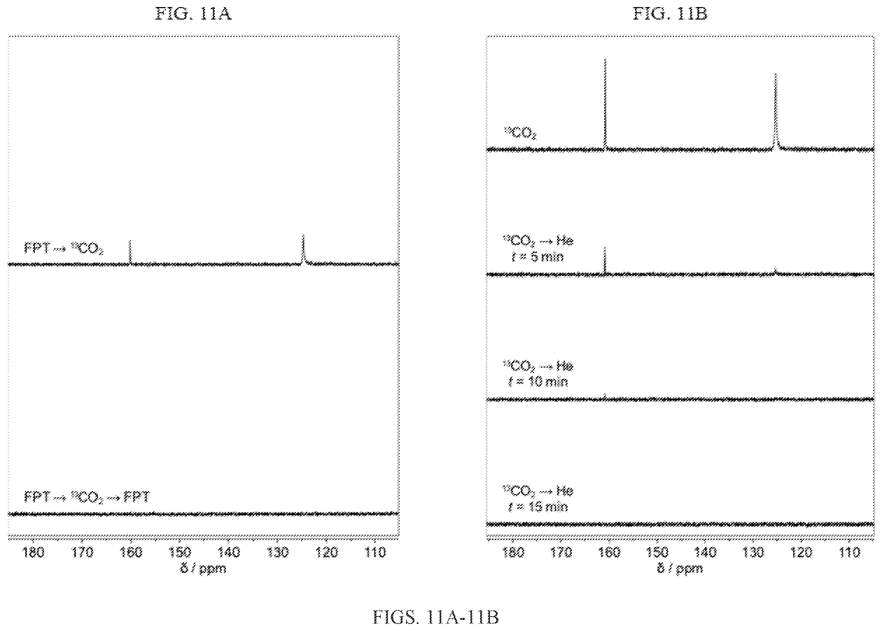

Isotope labeled NMR experiments provide evidence of the lability of the N—C bond within the carbamic acid. The ¹³C NMR spectrum of an aqueous solution of A-QDs at pH 6.1 bubbled with ¹³CO₂ shows the resonances of both ¹³C-labeled carbamic acid and dissolved ¹³CO₂, but amount and ratio of the two species depends on the degree to which the sample has been degassed by freeze-pump-thaw (FPT) or purging with He. An array of experiments show that (i) FPT removes all CO₂ from the system, even the CO₂ bound as carbamic acid, (ii) the formation of carbamic acid is reversible under mild conditions in our system, and (iii) purging the sample with He removes more freely diffusing CO₂ than carbamic acid (FIGS. 11A-11B). Clearly, the amine does “trap” the CO₂, but with a labile bond.

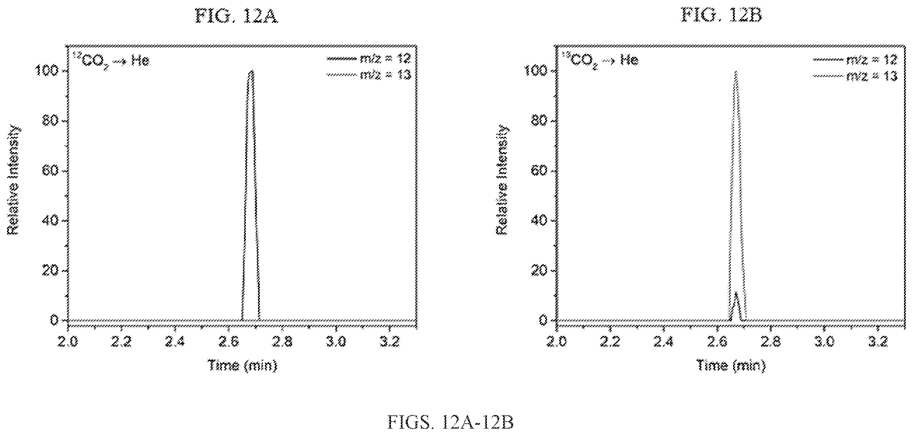

Interestingly, the A-QD-CoTPPS system efficiently reduces low concentrations of CO₂ to CO (75-10 vol. %, Ar balanced) and produces a small amount of CO even when exposed to air and then purged with Ar instead of CO₂, but does not produce CO when subjected to freeze-pump-thaw cycles before purging with Ar (Table 2). The latter result suggests that the amines on the QD surface may also be suitable for direct capture of CO₂ from air, as has been recently reported for tetraamine-appended metal-organic frameworks (Kim et al. Science 369, 392-396 (2020)), and that the resulting carbamic acids can serve as precursors to CO. This conclusion is supported by experiments in which ¹³CO was produced from samples which were purged with ¹³CO₂ but then the headspace was evacuated before illumination (FIGS. 12A-12B). The detection of ¹³CO₂ in the headspace of these samples after 18 hours of illumination further support the existence of a dynamic equilibrium between all three forms/phases of CO₂.

This sequestration of CO₂ as an activated—i.e., bent—carbamic acid may give the A-QDs an advantage over the TMA-QDs, and over the [Ru(bpy)₃]²⁺ system, in the photocatalytic reduction of CO₂ to CO. The dynamic equilibrium of the carbamic acid with free CO₂ dissolved and in the headspace allows the carbamic acid to serve as regenerable reaction intermediate, a catalyst-proximate reservoir for CO₂ and a direct or indirect precursor to the CO₂-bound porphyrin. This function is especially important in a pure (non buffered) water system because it effectively increases the solubility of CO₂. A similar strategy is employed in catalytic hydrogenations of CO₂ to MeOH, where ammonium carbamate is used as a CO₂ source for MeOH (Rezayee et al. J. Am. Chem. Soc. 2015, 137, 1028-1031; Mathis, C. L.; Geary, J.; Ardon, Y.; Reese et al. J. Am. Chem. Soc. 2019, 141, 14317-14328), but only at elevated temperatures. Since the N—C bond of our carbamic acid precursor is much weaker than that of the carbamate bond, we do not need elevated temperatures or other stimuli to utilize it as a precursor.

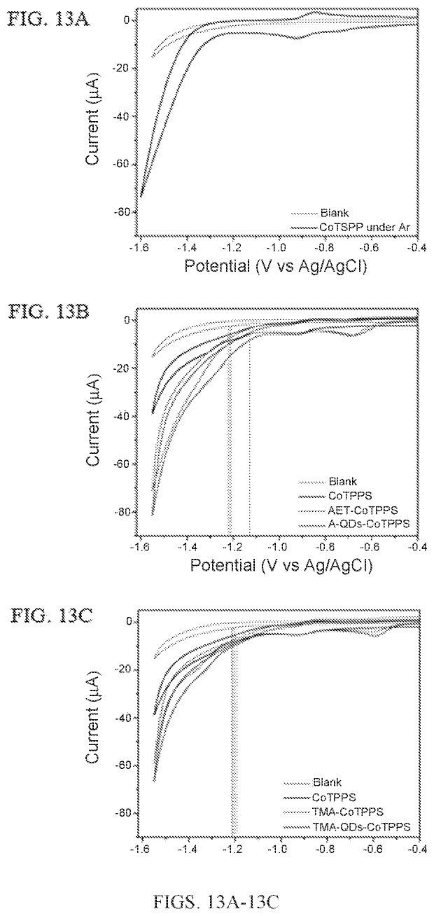

The A-QDs lower the onset potential for catalytic CO₂ reduction. We find direct evidence for the promotion of CO₂ reduction by the sequestration of CO₂ as carbamic acid in the electrochemical response of CoTPPS in the absence or presence of the two types of QDs or their respective free ligands (FIG. 5D and FIGS. 13A-13C). The cyclic voltammetry (CV) for CoTPPS recorded in a CO₂-saturated aqueous solution (pH 6.5 before CO₂ purging, supported with 0.1 M KCl) shows two redox events corresponding to Co^{II}TPPS/[Co^{I}(TPPS)]⁻ and [Co^{I}(TPPS)]⁻/[Co^{I}(TPPS^{⋅-})]²⁻ (FIG. 5D). While there is no significant change at the first reduction wave under CO₂ vs Ar (FIGS. 13A-13C), the formation of the reduced porphyrin intermediate [Co^{I}(TPPS^{⋅-})]²⁻ is coupled with the rise of catalytic current in a CO₂ atmosphere. This result is consistent with the published catalytic cycle for CoTPPS (Call 2019), which indicates that [Co^{I}(TPPS^{⋅-})]²⁻ is the species to which CO₂ binds affording [Co^{III}(TPPS^{⋅-})(CO₂²⁻)]²⁻, which is then protonated to [Co^{III}(TPPS^{⋅-})(CO₂H⁻)]⁻. Subsequent steps of C—O bond cleavage coupled with protonation and water elimination regenerate the initial form of the catalyst.

FIG. 5D shows that the onset potential for catalytic CO₂ reduction shifts anodically by 80 mV, from −1.21 V for CoTPPS to −1.13 V vs Ag/AgCl for A-QDs-CoTPPS, but that no meaningful changes in this potential occur upon addition of TMA-QDs, or AET or TMA ligands without QDs (FIGS. 13A-13C). This result confirms that it is the presence of QD-bound carbamic acid (the species present in samples of A-QDs bubbled with CO₂) that enables this reduction in onset potential for catalysis. A peak at ca. −0.6 V vs. Ag/AgCl is possibly attributable to ligand-coordinated CoTPPS at the high concentrations used for recording the CVs, but photocatalytic experiments using the [Ru(bpy)₃]²⁺-CoTPPS system with TMA or AET added in the relevant concentrations confirms that the ligands alone (without QDs) have no beneficial effect on the photocatalysis, whether or not they coordinate the porphyrin (Table 3).

TABLE 3
Photocatalytic performance for the [Ru(bpy)₃]²⁺-CoTPPS system

| | | | | Reaction | | | | | |
|---|---|---|---|---|---|---|---|---|---|
| | | COTPPS | [Ru(bpy)₃]²⁺ | conditions | | Time | TON | | S_{CO} |
| Entry | Gas | (μM) | (μM) | (mM) | pH* | (h) | CO | H₂ | (%) |
| 1 | CO₂ | 0.25 | 500 | NaAsc (100) + | 8.4 | 18 | 5,630 | 797 | 87.6 |
| | | | | NaHCO₃ (100) | | | | | |
| 2 | CO₂ | 0.25 | 500 | NaAsc (100) + | 8.2 | 18 | — | 8 | — |
| | | | | NaHCO₃ (100) + | | | | | |
| | | | | AET (10) | | | | | |
| 3 | CO₂ | 0.25 | 500 | NaAsc (100) + | 8.4 | 18 | — | — | — |
| | | | | NaHCO₃ (100) + | | | | | |
| | | | | TMA (10) | | | | | |
| 4 | CO₂ | 0.25 | 500 | NaAsc (100) | 6.3 | 18 | 2,697 | 2,812 | 49.0 |
| 5 | CO₂ | 0.25 | 500 | NaAsc (100) + | 6.1 | 18 | — | 8 | — |
| | | | | AET (10) | | | | | |
| 6 | CO₂ | 0.25 | 500 | NaAsc (100) + | 6.2 | 18 | — | — | — |
| | | | | TMA (10) | | | | | |

Summary of the reaction conditions used for the photocatalytic experiments (the optimized concentrations for [Ru(bpy)₃]²⁺ and NaAsc were used as reported by Sakai and co-workers).
¹ The typical uncertainty for TON values is ≤5%.
*The pH was measured before bubbling gas.

The A-QDs may decrease the onset potential for catalysis through (i) an increase in the local proton concentration that facilitates the protonation step of the catalytic cycle, or (ii) hydrogen bonding interactions between the NH fragments of the carbamic acid and the CO₂ adduct coordinated to the metal center, which stabilize the latter and assist in C—O bond cleavage. Such “second-sphere” effects on the activation and transformation of CO₂ have been accomplished by, for example, the phenol-based pendants on iron tetraphenylporphyrins (Costentin et al. Science 2012, 338, 90-94; Costentin et al. Proc. Natl. Acad. Sci. U.S.A. 2014, 111, 14990-14994), the amide or urea arms on iron tetraphenylporphyrins (Nichols et al. Chem. Sci. 2018, 9, 2952-2960; Gotico et al. Angew. Chemie Int. Ed. 2019, 58, 4504-4509), and the iron hangman porphyrin with guanidinium group (Margarit et al. Organometallics 2019, 38, 1219-1223).

Additional data with CoTCPP. An experiment was conducted comparing the photocatalytic performance of the CoTPPS catalyst with a CoTCPP catalyst. CoTCPP was synthesized according to a literature procedure (Lin et al. Angew. Chem. Int. Ed. 2016, 55, 13739-13743). Data in FIG. 12 shows TON_{CO} and TON_{H2} for samples containing 2.5 μM of A-QDs, 25 mM of NaAsc, and 0.25 μM of CoTCPP or CoTPPS prepared using 2.0 mL of CO₂-saturated H₂O, and irradiated with 450 nm light (140 mW·cm⁻²) for 18 hours. The pH was 6.0-6.1 before bubbling with CO₂. Error bars indicate standard error of the mean, calculated from two to three runs, and the typical uncertainty is ≤5%. The TON_{CO} was 28,282.

Preferred embodiments of this invention are described herein, including the best mode known to the inventors for carrying out the invention. Variations of those preferred embodiments may become apparent to those of ordinary skill in the art upon reading the foregoing description. Moreover, any combination of the above-described elements in all possible variations thereof is encompassed by the invention unless otherwise indicated herein or otherwise clearly contradicted by context.

1. A method of converting carbon dioxide to carbon monoxide, the method comprising:
providing a reaction mixture comprising quantum dots, a cobalt(III) porphyrin compound, and a reducing agent, in water;
adding carbon dioxide to the reaction mixture; and
illuminating the reaction mixture with light.

2. The method of claim 1, wherein the quantum dots are core/shell quantum dots comprising a CuInS₂ core and a ZnS shell.

3. The method of claim 1 or claim 2, wherein the quantum dots further comprise a capping molecule on the surface of the quantum dots.

4. The method of claim 3, wherein the capping molecule comprises a thiol moiety and an amine moiety.

5. The method of claim 4, wherein the capping molecule is 2-aminoethanethiol.

6. The method of any one of claims 1-5, wherein the quantum dots are present in the mixture at a concentration of about 1 μM to about 5 μM.

7. The method of any one of claims 1-6, wherein the cobalt(III) porphyrin compound is selected from [{meso-tetra(4-sulfonatophenyl)porphyrinato}cobalt(III)] and [{meso-tetra(4-carboxyphenyl)porphyrinato}cobalt(III)].

8. The method of any one of claims 1-7, wherein the cobalt(III) porphyrin compound is is present in the reaction mixture at a concentration of about 0.10 μM to about 5.0 μM.

9. The method of any one of claims 1-8, wherein the reducing agent is selected from sodium ascorbate, tris(carboxyethyl)phosphine, and a mixture thereof.

10. The method of any one of claims 1-9, wherein the reducing agent is present in the reaaction mixture at a concentration of about 5 mM to about 100 mM.

11. The method of any one of claims 1-10 wherein the reaction mixture does not comprise an organic solvent or a buffer.

12. The method of any one of claims 1-11, wherein the reaction mixture has a pH of about 6 to about 7.

13. The method of any one of claims 1-12, comprising illuminating the reaction mixture with light at a wavelength of about 450 nm.

14. The method of claim 13, comprising illuminating the reaction mixture with a 450-nm light-emitting diode.

15. The method of any one of claims 1-14, comprising illuminating the reaction mixture for about 18 hours to about 96 hours.

16. The method of any one of claims 1-15, wherein the reaction mixture is contained within a reaction vessel, and carbon dioxide is added to the reaction vessel at a pressure of about 1 atm.

17. A composition comprising:
quantum dots comprising a CuInS₂ core, a ZnS shell, and a capping molecule comprising an amino group;
a cobalt(III) porphyrin compound;
a reducing agent; and
water.

18. The composition of claim 17, wherein the capping molecule is 2-aminoethanethiol.

19. The composition of claim 17 or claim 18, wherein the cobalt(III) porphyrin compound is selected from [{meso-tetra(4-sulfonatophenyl)porphyrinato}cobalt(III)] and [{meso-tetra(4-carboxyphenyl)porphyrinato}cobalt(III)].

20. The composition of any one of claims 17-19, wherein the reducing agent is selected from sodium ascorbate, tris(carboxyethyl)phosphine, and a mixture thereof.

21. The composition of any one of claims 17-20, further comprising carbon dioxide.
